(19) United States
(12) Patent Application Publication
(10) Pub. No.: US 2019/0311385 A1
(43) Pub. Date: Oct. 10, 2019

(54) DEMAND PREDICTION SYSTEM, DEMAND PREDICTION METHOD, AND PROGRAM

(71) Applicant: Panasonic Intellectual Property Management Co., Ltd., Osaka (JP)

(72) Inventors: Kenichi KAWAGUCHI, Tokyo (JP); Shinichi OKADA, Tokyo (JP); Masamichi NAKAGAWA, Osaka (JP); Masataka EJIMA, Chiba (JP); Eiichiro TORIUMI, Tokyo (JP)

(21) Appl. No.: 16/461,510

(22) PCT Filed: Oct. 19, 2017
(86) PCT No.: PCT/JP2017/037786

§ 371 Date: May 16, 2019

(30) Foreign Application Priority Data
Nov. 30, 2016 (JP) 2016-233318

(51) Int. Cl. G06Q 30/02; G06Q 10/04; G06Q 10/08

(52) U.S. Cl. CPC G06Q 30/0205; G06Q 10/087; G06Q 10/04

(57) ABSTRACT

A collection unit of this demand prediction system collects a plurality of event information that have current or future events and location information indicating locations of the events. An extraction unit extracts event information indicating the event in a predetermined range, which includes the location of a shop from the plurality of event information collected by the collection unit based on the location information. A prediction unit predicts a demand of goods varying at the shop according to the event indicated by the event information extracted by the extraction unit, based on actual result information on a past event corresponding to the event indicated by the event information extracted by the extraction unit. An output unit outputs demand prediction information indicating the demand of goods predicted by the prediction unit.

### TECHNICAL FIELD

The present disclosure relates to a demand prediction system and the like that predict demand of goods in a shop.

### BACKGROUND ART

The system described in Japanese Patent Unexamined Publication No. 2002-007875 specifies special sale items in an external environment at the present time for each target based on a database created based on information on the external environment. As a result, this system responds to the external environment in real time to specify best-seller goods and make a bargain sale for those goods, so that it is possible to provide the goods desired by purchasers at a reasonable price, and promote sales automatically.

### CITATION LIST

### Patent Literature

PTL 1: Japanese Patent Unexamined Publication No. 2002-007875

### SUMMARY

A demand prediction system according to an aspect of the present disclosure includes a collection unit, an extraction unit, a prediction unit, and an output unit.

The collection unit collects a plurality of event information including event information having a current or future event and location information indicating the location of the event through a communication network.

An extraction unit extracts event information indicating the event in a predetermined range, which includes a location of a shop from the plurality of event information collected by the collection unit based on the location information.

A prediction unit predicts a demand of goods varying at the shop according to the event indicated by the event information extracted by the extraction unit based on actual result information on past events corresponding to the event indicated by the event information extracted by the extraction unit.

An output unit outputs demand prediction information indicating the demand of goods predicted by the prediction unit.

A demand prediction method according to the present disclosure includes the steps of collecting, extracting, predicting, and outputting.

The step of collecting collects a plurality of event information including event information having a current or future event and location information indicating location of the event through the communication network.

The step of extracting extracts event information indicating the event in a predetermined range, which includes the location of a shop from the plurality of event information collected by the collecting based on the location information.

The step of predicting predicts a demand of goods varying at the shop according to the event indicated by the event information extracted by the extracting based on actual result information on past events corresponding to the event indicated by the event information extracted by the extracting.

The step of outputting outputs demand prediction information indicating the demand of goods predicted in the predicting.

The program according to the present disclosure causes a computer to execute the demand prediction method described above.

### BRIEF DESCRIPTION OF DRAWINGS

FIG. 1 is a block diagram showing a configuration of a demand prediction system according to an embodiment.

FIG. 2 is a flowchart showing an operation of the demand prediction system according to the embodiment.

FIG. 3 is a conceptual diagram showing a processing of the demand prediction system according to the embodiment.

FIG. 4 is a conceptual diagram showing an application example of the demand prediction system according to the embodiment.

FIG. 5 is a diagram showing an example related to an event according to the embodiment.

FIG. 6 is a diagram showing an example related to a place according to the embodiment.

FIG. 7 is a conceptual diagram showing a first example of demand prediction according to the embodiment.

FIG. 8 is a conceptual diagram showing a second example of demand prediction in the embodiment.

FIG. 9 is a conceptual diagram showing a third example of demand prediction in the embodiment.

FIG. 10 is a conceptual diagram showing a fourth example of demand prediction in the embodiment.

### DESCRIPTION OF EMBODIMENT

The system described in Japanese Patent Unexamined Publication No. 2002-007875 is applied to an online shop. However, in an actual shop, there is a possibility that demand of goods varies greatly according to an event in the vicinity of the shop. As a result, the demand of goods cannot be appropriately predicted, and the goods cannot be appropriately provided, in some cases.

A demand prediction system according to one aspect of the present disclosure includes a collection unit, an extraction unit, a prediction unit, and an output unit. The collection unit collects a plurality of event information, each of which indicates a current or future event and includes location information indicating a location of the event, through a communication network.

The extraction unit extracts event information indicating the event in a predetermined range, which includes the location of a shop from the plurality of event information collected by the collection unit based on the location information. The prediction unit predicts a demand of goods varying at the shop according to the event indicated by the event information extracted by the extraction unit based on actual result information on past events corresponding to the event indicated by the event information extracted by the extraction unit. The output unit outputs demand prediction information indicating the demand of goods predicted by the prediction unit.

As a result, the demand prediction system can appropriately predict demand of goods varying at the shop according to current or future event, and can provide information indicating the predicted demand of goods. Therefore, the demand prediction system can support the appropriate provision of goods.

For example, the predetermined range may be a range that is defined as a range influencing the demand of goods at the shop.

As a result, the demand prediction system can appropriately predict the demand of goods at the shop, based on the range of events that influence the demand of goods at the shop.

In addition, for example, the event indicated by the event information extracted by the extraction unit may be route-related events, road-related events, special events, or current trend in a predetermined range.

Thereby, the demand prediction system can appropriately predict the demand of goods at the shop based on the route-related events, the road-related events, the special events, or the current trend in the predetermined range.

In addition, for example, the prediction unit may predict a flow of people (flow of crowd) varying according to the event indicated by the event information extracted by the extraction unit based on actual result information of the past event, and may predict the demand of goods based on the predicted flow of people.

As a result, the demand prediction system can appropriately predict the flow of people varying according to the current or future event, and can appropriately predict the demand of goods varying according to the variation of the flow of people.

In addition, for example, the prediction unit may predict at least one of a traffic route, a traffic volume, and a number of visits varying according to the event indicated by the event information extracted by the extraction unit as the flow of people.

As a result, the demand prediction system can appropriately predict the traffic route, the traffic volume, and the number of visits varying according to the current or future event, and can appropriately predict the demand of goods varying according to a variation in the traffic route, the traffic volume, and the number of visits.

In addition, for example, the output unit may further output crowd prediction information indicating the flow of people predicted by the prediction unit.

As a result, the demand prediction system can provide information indicating appropriately predicted flow of people. Therefore, the demand prediction system can support the appropriate provision of goods.

In addition, for example, the prediction unit may predict the flow of people and an attribute of a person included in the flow of people, based on the actual result information of the past event and may predict the demand of goods based on the predicted flow of people and the attribute.

Thus, the demand prediction system can appropriately predict demand of goods based on the attribute of the person influenced by the event.

Further, for example, the prediction unit may predict at least one of gender, age and preference of the person included in the flow of people as the attribute.

As a result, the demand prediction system can appropriately predict the demand of goods based on the gender or age influenced by the event.

Further, for example, the output unit may further output attribute prediction information indicating the attribute predicted by the prediction unit.

Thus, the demand prediction system can provide information indicating the attribute of the person influenced by the event.

Therefore, the demand prediction system can support the appropriate provision of goods.

Furthermore, these comprehensive or specific aspects may be implemented in a system, a method, an integrated circuit, a computer program or a non-transitory recording medium such as a computer-readable CD-ROM, and may be implemented in any combination of systems, devices, methods, integration circuits, computer programs and recording media.

Hereinafter, an embodiment will be described in detail with reference to the drawings. It should be noted that all of the embodiment described below represent comprehensive or specific examples. Numerical values, shapes, materials, components, arrangement locations and connection modes of components, steps, order of steps, and the like shown in the following embodiment are merely examples and are not intended to limit the present invention. In addition, among components in the following embodiment, components not described in the independent claims representing the most significant concept are described as optional components.

### EMBODIMENT

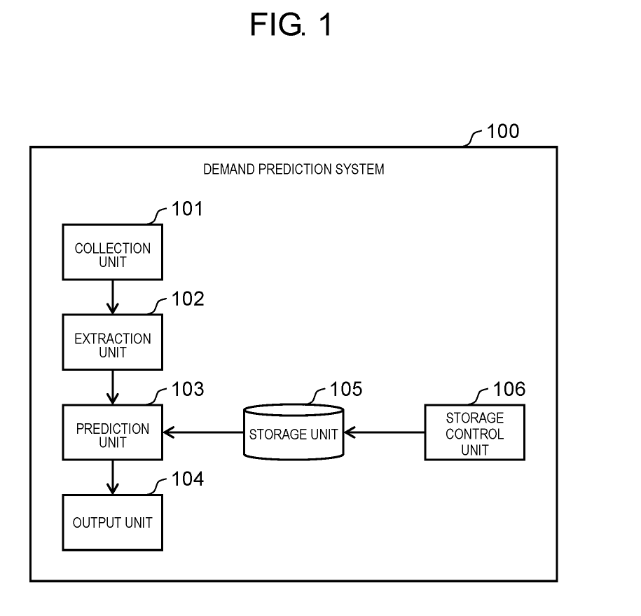

FIG. 1 is a block diagram showing a configuration of a demand prediction system according to the present embodiment. As shown in FIG. 1, demand prediction system 100 includes collection unit 101, extraction unit 102, prediction unit 103, output unit 104, storage unit 105, and storage control unit 106. Then, demand prediction system 100 predicts the demand of goods at the shop. For example, demand prediction system 100 is a computer. Demand prediction system 100 may include a single device or a plurality of devices.

In addition, demand prediction system 100 may be arranged inside a shop or outside the shop. For example, some or all of demand prediction system 100 may be located in the headquarters for a plurality of shops.

Collection unit 101 is a collector that collects a plurality of event information through a communication network. Collection unit 101 may be formed of a dedicated circuit or may be formed of a general-purpose circuit such as a general-purpose processor. In addition, collection unit 101 may have a terminal for wired communication, or may have an antenna for wireless communication. The communication network is the Internet, for example.

In addition, the event information collected by collection unit 101 is information indicating current or future event, and is information including location information indicating the location of the event. A plurality of event information may indicate one event, or one event information may indicate a plurality of events. For example, events are train delay, service suspension, traffic jam, construction, special event, and current trend. The location of the event is specifically the location where the event occurred. The location of the event may be the location where the event occurred, or may be the area where the event occurred.

For example, collection unit 101 accesses various Web pages on the Internet and collects event information posted in various Web pages. The various Web pages may include a municipality homepage or an event homepage. Further, a page of FACEBOOK (registered trademark) may be included, a page of TWITTER (registered trademark) may be included, or a page of another social network service (SNS) may be included.

Extraction unit 102 is an extractor that extracts event information indicating the event in a predetermined range, which includes the location of the shop from the plurality of event information collected by collection unit 101 according to the location information. Extraction unit 102 may be formed of a dedicated circuit or may be formed of a general-purpose circuit such as a general-purpose processor. Further, the predetermined range including the location of the shop is a range that is defined as a range influencing the demand of goods at the shop, for example.

That is, extraction unit 102 extracts event information indicating the event in a range influencing the demand of goods of the shop by performing filtering of a plurality of event information collected by collection unit 101 based on location information. The event indicated by the event information extracted by extraction unit 102 is route-related events, road-related events, special events, and current trend in a predetermined range, for example. Hereinafter, the event indicated by the event information extracted by extraction unit 102, that is, current or future events in a predetermined range including the location of the shop may be referred to as a target event.

The predetermined range including the location of the shop may be updated according to the result of the change in the demand of goods at the time of occurrence of the event. For example, when there is no or little change in demand of goods at the time of occurrence of an event, the predetermined range may be slightly changed, and when the change in demand of goods at the time of the occurrence of an event is large, the predetermined range may be greatly changed.

Further, extraction unit 102 may extract one event information from the plurality of event information collected by collection unit 101, or may extract two or more event information from the plurality of event information collected by collection unit 101. Further, extraction unit 102 may extract one event information obtained by integrating two or more event information from the plurality of event information collected by collection unit 101.

Further, extraction unit 102 may further include an analysis unit (analyzer) for analyzing the collected event information or the extracted event information.

Prediction unit 103 is a predictor that predicts the demand of goods varying at the shop according to a target event based on the actual result information of the past event corresponding to the target event. Prediction unit 103 may be formed of a dedicated circuit or may be formed of a general-purpose circuit such as a general-purpose processor. Past event corresponding to the target event is past event of the same type as the target event and is past event that is the same as or similar to the target event.

For example, when the same event as the target event is present in the past, the same past event as the target event is applied. Then, when the same event as the target event does not exist in the past, a past event similar to the target event is applied. More specifically, when the target event is an event that is repeatedly held, the same past event as the target event may be applied. Then, when the target event is a single event or an initial event, a past event similar to the target event may be applied.

In addition, prediction unit 103 may predict the flow of people varying according to the target event based on the actual result information of the past event, and predict the demand of goods based on the predicted flow of people. At that time, prediction unit 103 may predict at least one of the traffic route, the traffic volume, and the number of visits varying according to the target event as the flow of people.

In addition, prediction unit 103 may predict the flow of people varying according to the target event and the attribute of the person included in the flow of people based on the actual result information of the past event, and may predict the demand of goods based on the predicted the flow of people and the attribute. At that time, prediction unit 103 may predict at least one of gender, age and preference of a person included in the flow of people as the attribute of a person included in the crowd.

For example, the actual result information of the past event may indicate the demand of goods at the time of occurrence of the past event, may indicate the flow of people at that time, and indicate the attribute of the person included in the flow of people.

In addition, the flow of crowd means people's flow, but not limited to walkers. The flow of people may be a flow of a vehicle such as a car including a person. In addition, the attribute of a person included in the flow of people may be an attribute of the majority out of a plurality of people included in the flow of people. Alternatively, as the attribute of the person included in the crowd, the ratio of a plurality of people included in the flow of people may be used. For example, the gender ratio, age ratio, and the like of the plurality of people included in a flow of people may be used as attributes of the people included in the flow of people.

In addition, the preference of a person included in the flow of people may be goods preference for each individual (preference goods), goods preference according to gender or age, preference for new product, and the like, for example. In addition, the preference of the person included in the flow of people may correspond to the major preferences of the plurality of people included in the crowd. Prediction unit 103 may predict such preference as an attribute of the people included in the flow of people.

Output unit 104 is an output device that outputs demand prediction information indicating the demand of goods predicted by prediction unit 103. Output unit 104 may be formed of a dedicated circuit or may be formed of a general-purpose circuit such as a general-purpose processor.

Further, output unit 104 may have a terminal for wired communication, or may have an antenna for wireless communication. Then, output unit 104 may output the demand prediction information by transmitting the demand prediction information by information communication. For example, output unit 104 may transmit the demand prediction information to the communication network. In this case, collection unit 101 and output unit 104 may be a common communication device for performing communication through the communication network, or may include the common communication device.

Further, output unit 104 may have a display for outputting the demand prediction information as an image. Alternatively, output unit 104 may output the demand prediction information to an external display. Further, output unit 104 may have a speaker for outputting the demand prediction information as voice. Alternatively, output unit 104 may output the demand prediction information to an external speaker. Further, output unit 104 may have a printer for performing output by printing the demand prediction information. Alternatively, output unit 104 may output the demand prediction information to an external printer.

Storage unit 105 is a storage unit that stores the actual result information of the past event and the like. Storage unit 105 may be formed of a dedicated circuit such as a dedicated memory or may be formed of a general-purpose circuit such as a general purpose memory. Storage unit 105 may be a volatile memory or a non-volatile memory.

For example, prediction unit 103 predicts demand of goods by referring to the actual result information stored in storage unit 105. It should be noted that storage unit 105 need not be a component of demand prediction system 100. Prediction unit 103 may predict demand of goods by referring to the actual result information stored in the external storage device.

Storage control unit 106 is a storage controller that acquires the actual result information of the target event and causes storage unit 105 to store the acquired actual result information. Storage control unit 106 may be formed of a dedicated circuit or may be formed of a general-purpose circuit such as a general-purpose processor.

Storage unit 105 may have storage control unit 106.

For example, the actual result information of the target event may indicate the demand of goods at the time of occurrence of the target event, may indicate the flow of people at that time, and indicate the attribute of the person included in the flow of people. Storage control unit 106 may acquire the actual result information of the target event from a sensor, a point of sales (POS) system, and the like.

Storage control unit 106 is an optional component, and demand prediction system 100 may not have storage control unit 106.

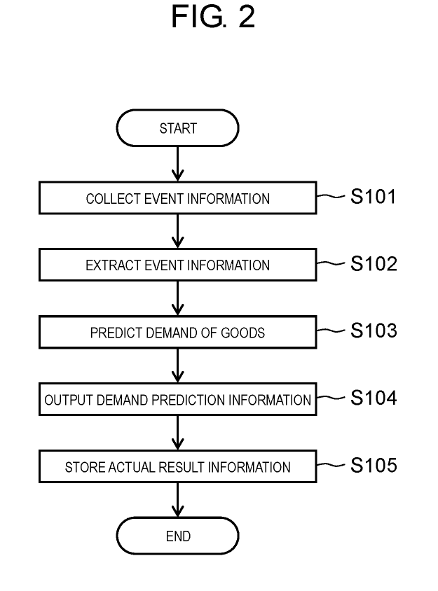

FIG. 2 is a flowchart showing an operation of the demand prediction system 100 shown in FIG. 1. Demand prediction system 100 predicts the demand of goods in a shop by performing the operation shown in FIG. 2.

First, collection unit 101 collects a plurality of event information through a communication network (S101). Next, extraction unit 102 extracts event information indicating target events in a predetermined range, which includes the location of the shop from the plurality of event information collected by collection unit 101 (S102). Next, prediction unit 103 predicts demand of goods varying at the shop according to the target event based on the actual result information on the past event corresponding to the target event (S103).

Next, output unit 104 outputs the demand prediction information indicating the demand of goods predicted by prediction unit 103 (S104). Then, storage control unit 106 acquires the actual result information of the target event and causes storage unit 105 to store the acquired actual result information (S105).

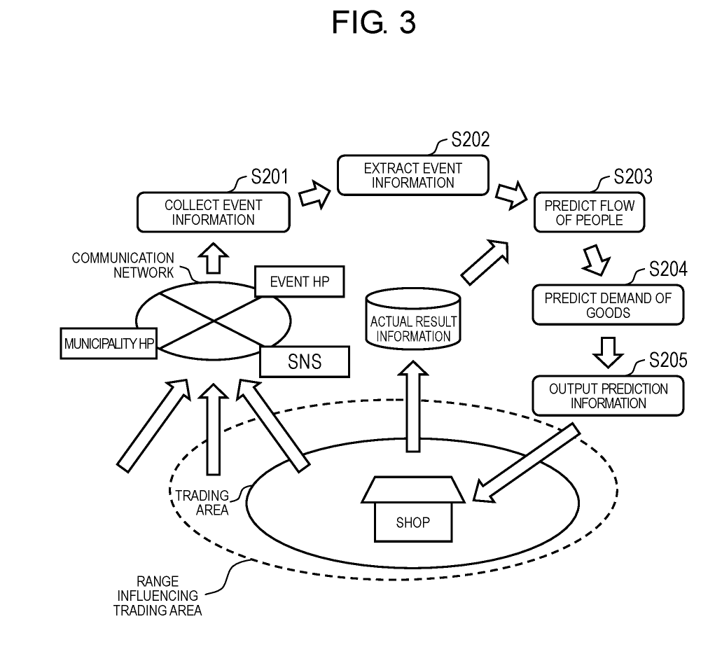

FIG. 3 is a conceptual diagram showing the processing of demand prediction system 100 shown in FIG. 1. In FIG. 3, the operation shown in FIG. 2 is conceptually shown.

In this example, event information indicating events in various places in the current or future is transmitted by the municipality homepage, the event homepage, the social network service (SNS) page, and the like. Collection unit 101 collects a plurality of event information from these pages through the communication network (S201). The plurality of event information may include newly generated event information each time, or may include event information that is accumulated and posted from the past.

Next, extraction unit 102 extracts the event information indicating the event in a predetermined range, which includes the shop by performing a filtering of the collected event information according to the location information included in the collected event information (S202).

Extraction unit 102 may further analyze the collected event information or the extracted event information. For example, extraction unit 102 may classify the event information into one of a plurality of types. Extraction unit 102 may determine whether it corresponds to an event, a construction, a disaster, and the like as a non-periodic event, or may determine whether it corresponds to a traffic jam and the like as a periodic event.

Further, extraction unit 102 may acquire the attribute of the event indicated by the event information. The attribute of the event may include the occurrence time of year, the occurrence time, the occurrence location, the scale, and the like of the event, for example.

Next, prediction unit 103 predicts a flow of people varying according to the target event indicated by the extracted event information (S203). Specifically, prediction unit 103 predicts a flow of people varying according to the target event based on the actual result information of the past event corresponding to the target event. More specifically, prediction unit 103 predicts the flow of people varying according to the target event based on the actual result information of the past event that is the same as or similar to the target event in terms of type and attribute, and the like.

In addition, for example, the actual result information of the past event indicates the flow of people varied according to past event. Then, prediction unit 103 predicts the flow of people varying according to the target event according to the flow of people indicated by the actual result information on the past event corresponding to the target event.

Further, as the actual result information on past event, the traffic route, the traffic volume, and the number of visits, and the like varied according to past event may be indicated as the flow of people. Then, prediction unit 103 may predict the traffic route, the traffic volume, and the number of visits varying according to the target event as the flow of people based on the actual result information of the past event. For example, prediction unit 103 predicts the variation in the traffic route in the vicinity of the shop, a time-based change in the number of people moving in front of the shop, and a time-based change in the number of visits.

Further, prediction unit 103 may predict the attribute of the person in the flow of people varying according to the target event based on the actual result information of the past event corresponding to the target event. Specifically, the attribute of the person in the flow of people varying according to the target event is the attribute of the participant of the event. For example, the actual result information of the past event indicates the attribute of the person in the flow of people varied according to the past event. Then, prediction unit 103 predicts the attribute of the person in the flow of people varying according to the target event according to the attribute indicated by the actual result information on the past event corresponding to the target event.

In addition, the actual result information on the past event may indicate the gender, age, preference, moving purpose and the like of a person included in the flow of people that varied according to past event as the attribute of the person. Then, prediction unit 103 may predict the gender, age, preference, moving purpose, and the like of the person included in the flow of people varying according to the target event as the attribute of the person based on the actual result information on the past event.

Next, prediction unit 103 predicts the demand of goods varying at the shop according to the target event based on the predicted flow of people and the attribute, and the like (S204). For example, prediction unit 103 predicts purchased goods, purchase time, purchase quantity, and the like as demand of goods. In the prediction of the demand of goods, the type and attribute of the target event may be reflected.

For example, prediction unit 103 gives the weight of the demand of goods for each good based on the attribute of the target event and the attribute of the person in the flow of people varying according to the target event to predict the demand of goods. Specifically, prediction unit 103 predicts the demand of goods by giving the weight of the demand of goods for each good such as 1.5 times the usual demand for drinks, 1.2 times the usual demand for foods, and the like based on the predicted flow of people and the like. In addition, the causal data such as time and day of the week may be reflected in the giving the weight.

For example, prediction unit 103 predicts that the demand of goods for goods for men increases when it is predicted that the number of visits to men increases based on the predicted flow of people and attribute. In addition, prediction unit 103 predicts that the demand of goods for goods for young people increases when it is predicted that the number of visits to the young people increases based on the predicted flow of people and attribute.

Further, prediction unit 103 may determine recommended purchase goods, purchase time, purchase quantity, and the like based on the predicted demand of goods. In addition, prediction unit 103 may determine the recommended shift of the crew (the recommended working time of a clerk) based on the predicted demand of goods.

Further, prediction unit 103 may determine a recommended goods delivery plan based on the predicted demand of goods. For example, there is a possibility that there are a shop where the demand of goods increases and a shop where the demand of goods decreases according to the variation in flow of people. Therefore, in the determination of the goods delivery plan, prediction unit 103 may change the delivery of the goods from the shop where the demand of goods decreases to the shop where the demand of goods increases.

It should be noted that demand prediction system 100 may include the determination unit, instead of prediction unit 103, the determination unit may determine the recommended purchase, the recommended shift of the crew, the recommended goods delivery plan, and the like.

In addition, in this example, prediction unit 103 predicts the flow of people based on the actual result information on the past event and predicts the demand of goods based on the predicted flow of people. However, prediction unit 103 may predict the demand of goods based on the actual result information on the past event without predicting the flow of people. In this case, the actual result information on the past event may indicate the demand of goods varied according to the past event.

Next, output unit 104 outputs demand prediction information indicating the predicted demand of goods (S205). For example, output unit 104 outputs demand prediction information indicating the predicted purchase goods, purchase time, purchase quantity, and the like. Output unit 104 may output the demand prediction information and notify the manager of the shop of the predicted demand of goods.

Further, output unit 104 may output information indicating the target event together with the type and attribute of the target event, and notify the manager of the shop of these information. Further, output unit 104 may output the crowd prediction information indicating the predicted flow of people to notify the manager of the shop of the predicted flow of people, or may notify the security company and the police, and the like of the predicted flow of people. Further, output unit 104 may output attribute prediction information indicating the attribute of the person in the predicted flow of people to notify the manager of the shop of the attribute of the person in the predicted crowd.

In addition, output unit 104 may output purchase recommended information indicating recommended purchase goods, purchase time, purchase quantity, and the like to notify the manager of the shops of these information. In addition, output unit 104 may output the recommended shift information indicating the recommended shift of the crew to notify the manager of the shop of the recommended shift of the crew. In addition, output unit 104 may output delivery recommended information indicating the recommended goods delivery plan to notify the manager who manages a plurality of shops of the goods delivery plan.

In addition, output unit 104 may output guidance information indicating the shop and the goods based on the predicted flow of people and the attribute of the person in the predicted flow of people to guide the goods at the shop to the person in the predicted flow of people. Such guidance information may be posted on a homepage of the shop in a communication network or may be individually transmitted by direct mail and the like, for example.

In addition, output unit 104 may output demand prediction information and input the demand prediction information to a purchase system, a work management system, a delivery system, and the like to support automatic purchase, work management and delivery based on the demand predict. In addition, output unit 104 may output purchase recommended information, recommended shift information, delivery recommended information, and the like and input them to the purchase system, the work management system, the delivery system, and the like.

After occurrence of the target event, storage control unit 106 causes storage unit 105 to store the actual result information of the target event. The actual result information of the target event may indicate the result of the demand of goods varied at the shop according to the target event or may indicate the result of the flow of people varied according to the target event. The actual result information stored in storage unit 105 is used as the actual result information on past event.

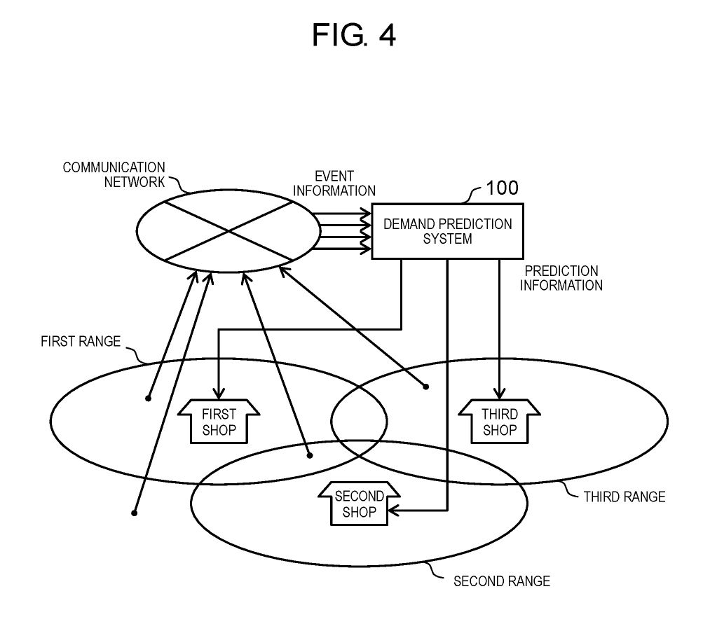

FIG. 4 is a conceptual diagram showing an application example of demand prediction system 100 shown in FIG. 1. Although one shop is shown in FIG. 3, demand prediction system 100 may be applied to a plurality of shops as shown in FIG. 4. That is, demand prediction system 100 may predict the demand of goods in each of a plurality of shops.

Specifically, demand prediction system 100 collects event information indicating events in various locations in the current or future. Then, demand prediction system 100 extracts event information indicating a predetermined range events including the shop (the first range, the second range, and the third range) with respect to each of a plurality of shops (the first shop, the second shop, and the third shop).

Then, demand prediction system 100 predicts the demand of goods with respect to each of the plurality of shops based on the extracted event information. Demand prediction system 100 outputs demand prediction information indicating the predicted demand of goods with respect to each of a plurality of shops.

Thereby, demand prediction system 100 can fully utilize a plurality of event information. Further, demand prediction system 100 can more easily utilize the actual result information such as the demand of goods at other shops in predicting the demand of goods, and the like at each shop.

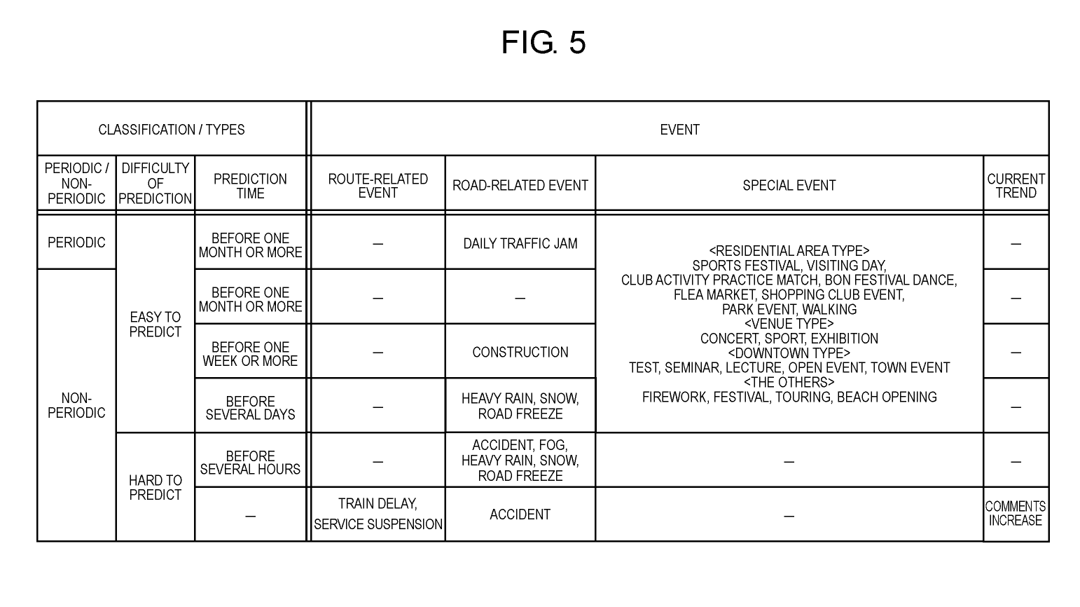

FIG. 5 is a diagram showing an example related to an event according to the embodiment. The event includes a route-related event, a road-related event, a special event, a current trend, and the like. The route-related event includes train delay and service suspension. The road-related event includes daily traffic jam, construction, road freezing and accidents. In addition, the road-related event may include heavy rain, snow, fog, and the like that influence traffic.

In addition, the special event include sports festival, visiting day, club activity practice match, Bon festival dance, flea market (flea market), shopping club event, park event, walking, concert, sport, exhibition, test, seminar, lecture, open event, town event, firework, festival, touring, beach opening, and the like. Further, the current trend includes an increase in positive comments, and the like.

For example, these events are classified into periodic event and non-periodic event. In addition, these events are classified into easily predictable event and non-easily predictable predict event. In addition, these events are classified according to predict time of year.

Collection unit 101 collects event information indicating an event as shown in FIG. 5. In addition, collection unit 101 may collect the event information based on the classification as shown in FIG. 5. For example, collection unit 101 may collect event information indicating future event with respect to an easily predictable special event and may collect event information indicating current event with respect to non-easily predictable route-related events. As a result, highly reliable event information is appropriately collected.

Alternatively, extraction unit 102 may extract the event information based on the classification as shown in FIG. 5. For example, extraction unit 102 may extract event information indicating future event with respect to an easily predictable special event and may extract event information indicating current event with respect to non-easily predictable route-related events. As a result, highly reliable event information is appropriately extracted.

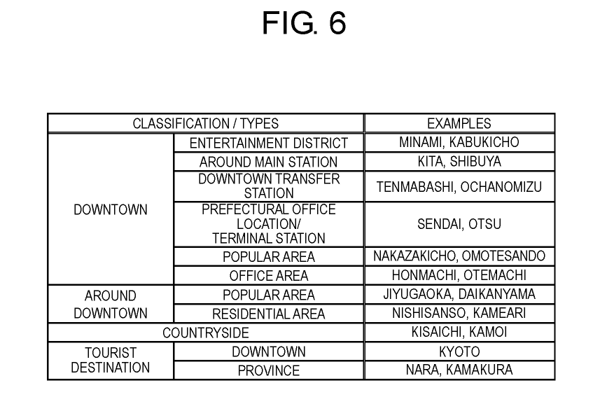

FIG. 6 is a diagram showing an example related to a place where the event shown in FIG. 5 occurs. According to the characteristic (type) of location, occurrence event and characteristic of occurrence event may differ in some cases.

Therefore, extraction unit 102 may extract the event information based on the characteristic of the place. For example, extraction unit 102 may preferentially extract event information indicating a route-related event with respect to a shop around the main station, and preferentially extract event information indicating road-related event with respect to a rural retail shop. As a result, the event information is appropriately extracted.

Further, for example, prediction unit 103 may refer to the actual result information of the past event by using that the characteristic of the location where the past event occurred matches or is similar to the characteristic of the location where the target event occurred, as the condition. As a result, appropriate actual result information is referred to.

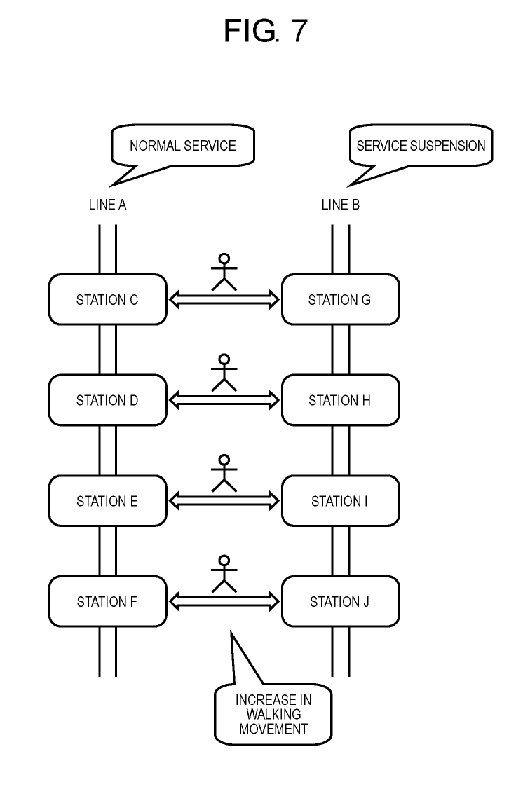

Next, a plurality of examples of demand prediction performed by demand prediction system 100 will be described with reference to FIGS. 7 to 10.

FIG. 7 is a conceptual diagram showing a first example of demand prediction performed by demand prediction system 100 shown in FIG. 1. This example corresponds to a route-related event, more specifically, an event of service suspension.

In this example, each of lines A and B is the lines of the train. In addition, the lines A and B are substantially parallel lines adjacent to each other. The line A includes C station, D station, E station and F station. The line B includes G station, H station, I station and J station. Currently, on the line B, service suspension is occurred. On the other hand, on the line A, normal service is performed.

In this example, demand prediction system 100 (extraction unit 102) extracts information of the operation information site, information of SNS, and the like as the event information indicating the target event. In particular, the basic information of the event is identified by the information of the operation information site and the real time information of the event is identified by the information of the SNS. For example, by the information of SNS, specific information such as “Stopped”, “It is moving, but the time of stopped is long and it is not almost moving”, “It is moving but it is too crowded to enter the ticket gate”, and “Fairly normal” is identified.

In demand prediction system 100 (prediction unit 103), walking movement between the lines A and B increases is predicted as the flow of people, based on the past actual result information on the same event. Specifically, it is predicted that there is an increase in the walking movement between the two stations with comparatively short distances, that is, between C and G stations, between the D and the H stations, between the E and the I stations, and between the F and J stations. Further, the time until normalization (for example, 1 to 3 hours, and the like) is predicted based on the actual result information.

Further, demand prediction system 100 may predict specific detour route based on the actual result information. Demand prediction system 100 may predict the traffic volume for each time based on the actual result information. Then, demand prediction system 100 predicts the demand of goods in each of the plurality of shops between the lines A and B for each time based on the predicted flow of people. Demand prediction system 100 may reflect the change in the amount of operation of line A, the amount of normal operation of line B, the amount of current operation of line B, and information of SNS in the prediction.

Further, demand prediction system 100 may determine the recommended purchase and the goods delivery plan based on the predicted demand of goods, and may notify a plurality of shops between lines A and B of the determined information.

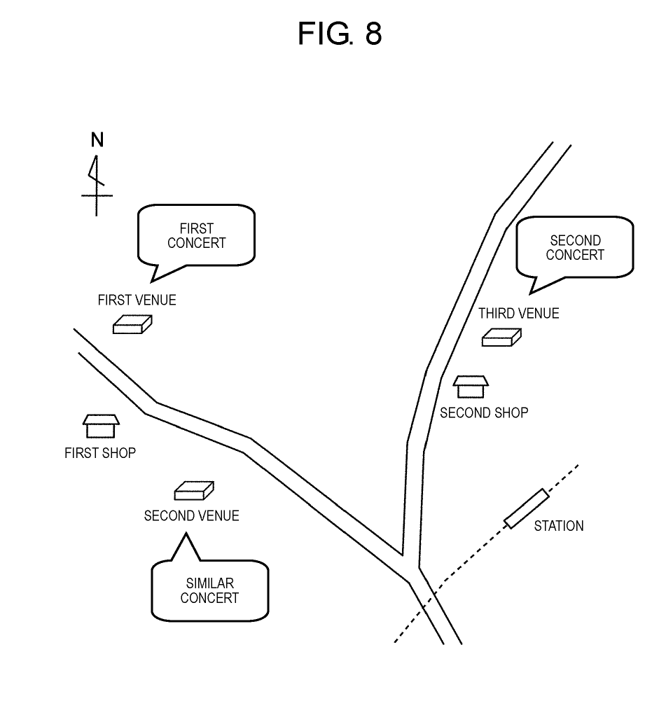

FIG. 8 is a conceptual diagram showing a second example of demand prediction performed by demand prediction system 100 shown in FIG. 1. This example corresponds to the special event, more specifically, the event of concert.

In this example, there are a first venue and a second venue in the vicinity of the first shop. In addition, there is a third venue in the vicinity of the second shop. Then, the first concert (target concert) is held at the first venue.

In this example, demand prediction system 100 (extraction unit 102) extracts information of notification site, information of news site, information of SNS, and the like as the event information indicating the target event. For example, at a notification site, a concert is announced several weeks ago and the holding of the concert, the date and time of the concert, the content of the concert, and the like are identified by the information of the notification site.

Then, demand prediction system 100 (prediction unit 103) predicts the number of audience (number of mobiles) of the concert and the like based on the past actual result information on the same event. For example, when a concert similar to the target concert is being held at the second venue in the past, the number of audience and the like of the target concert is predicted based on the actual result information of the similar concert.

For example, demand prediction system 100 may predict the number of audience and the like of the target concert by using past articles of news sites related to similar concerts as the actual result information. In addition, demand prediction system 100 may predict the distribution of people based on location information of people collected during the similar concert.

Further, demand prediction system 100 may predict attribute such as preference of the audience of the target concert based on the past actual result information of the past same event. For example, demand prediction system 100 may use SNS past information on similar concerts as the actual result information to predict the needs of the audience such as wanting beer, wanting tea, and wanting to eat ice.

As described above, demand prediction system 100 predicts the distribution and attribute of people based on the actual result information of past event. Further, demand prediction system 100 predicts the traffic volume in the vicinity of the shop on a time basis, based on the predicted number of audience and the like. Then, demand prediction system 100 predicts the demand of goods at the shop for each time.

Further, demand prediction system 100 may determine recommended purchase goods, purchase time, purchase quantity, and the like based on the predicted demand of goods. In addition, demand prediction system 100 may determine the recommended shift of the crew based on the predicted demand of goods.

Further, in the example described above, when the first concert is held at the first venue in the vicinity of the first shop, demand prediction system 100 predicts the demand of goods varying at the first shop according to the first concert based on the actual result information of the similar concert. When the second concert having the same contents as the first concert is held at the third venue in the vicinity of the second shop, demand prediction system 100 may predict the demand of goods varying at the second shop according to the second concert based on the actual result information of the first concert.

For example, even when demand prediction system 100 may predict the demand of goods varying at the second shop according to the second concert based on the flow of people in the vicinity of the first shop and the demand of goods at the first shop at the time of holding the first concert.

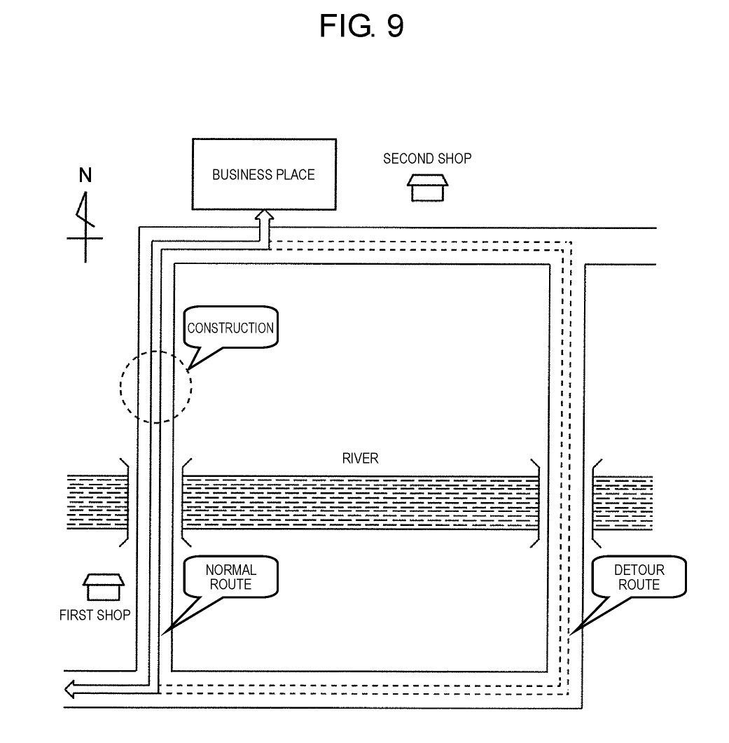

FIG. 9 is a conceptual diagram showing a third example of demand prediction performed according to demand prediction system 100 shown in FIG. 1. This example corresponds to a road-related event, more specifically, an event of construction.

In this example, a large number of people commute to the workplace across the river by a car. When the construction is carried out in the normal route for this commuting, a large number of people need to bypass to another route.

In this example, demand prediction system 100 (extraction unit 102) extracts information of notification site, information of SNS, and the like as the event information indicating the target event. For example, at a notification site, construction is notified a few weeks ago or a few months ago. Then, according to the information of the notification site, the occurrence of construction, the date and time of construction, the influence range of construction, and the like are identified. In addition, the time-based change of the congestion state which is changed according to the detour route and the weather, and the like is identified by the information of the SNS.

Demand prediction system 100 (prediction unit 103) predicts the detour route and the traffic volume in advance based on the actual result information of the past event similar to the target event. Information of SNS when similar construction work was carried out in the past may be used as the actual result information of the past event. In addition, information of the current SNS may be reflected in the prediction of the detour route and the traffic volume, and the future detour route and the traffic volume may be predicted. Then, demand prediction system 100 predicts the demand of goods for each time based on the predicted detour route and the traffic volume.

Further, demand prediction system 100 may determine recommended purchase goods, purchase time, purchase quantity, and the like based on the predicted demand of goods. In addition, demand prediction system 100 may determine the recommended shift of the crew based on the predicted demand of goods.

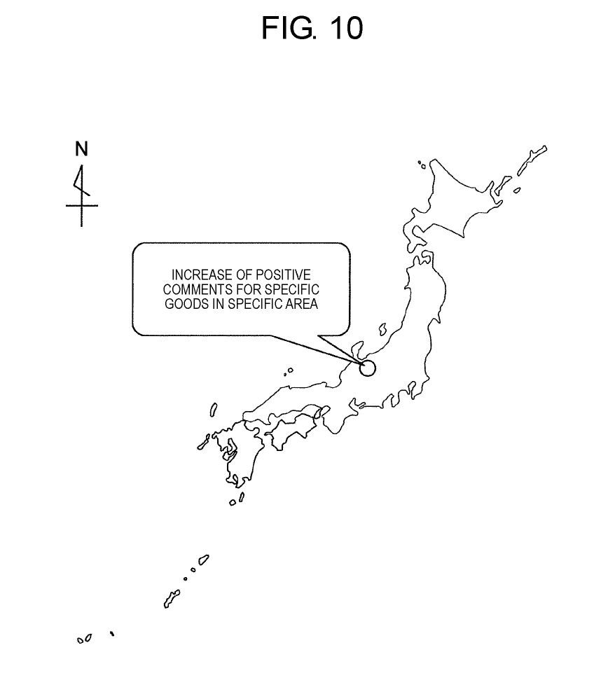

FIG. 10 is a conceptual diagram showing a fourth example of demand prediction performed by demand prediction system 100 shown in FIG. 1. This example corresponds to a current trend, more specifically an event of a comments increase.

For example, according to a television commercial or a television program at a local broadcasting station, a specific goods may be popular in a specific area in some cases. In such a case, positive comments on the specific goods increase in the specific area. The example of FIG. 10 corresponds to such an event.

In this example, demand prediction system 100 (collection unit 101) collects a plurality of event information included in a plurality of comments by collecting a plurality of comments in the SNS. For example, when specific goods become popular, positive comments on specific goods increase in the collected plurality of comments. Demand prediction system 100 collects a plurality of event information including event information indicating such a comments increase as an event, by collecting a plurality of comments.

Demand prediction system 100 (extraction unit 102) extracts the event information indicating the comments increase described above based on the collected a plurality of comments. In addition, the location information of the event information indicating the comments increase is based on the sender information and the like attached to the comment, and indicates the area where the comment is increasing as the location. Such location information is used for extracting event information.

That is, specifically, demand prediction system 100 (extraction unit 102) extracts event information indicating the comments increase in a region including a shop based on the collected a plurality of comments and their sender information, and the like. As a result, the event information indicating the target event is extracted from the plurality of collected event information.

demand prediction system 100 (prediction unit 103) predicts the demand of goods varying according to the target event at the shop based on the actual result information on the past event corresponding to the target event indicated by the extracted event information. The past event corresponding to the target event is event of a past comments increase on similar goods, for example. That is, demand prediction system 100 predicts the demand of goods based on the actual result information when the comments is increased in the past.

In addition, demand prediction system 100 may predict the flow of people (the number of visits) based on the actual result information on the past event. Then, demand prediction system 100 may predict the demand of goods with respect to a specific goods of which the comment is increasing, and a goods other than the specific goods, based on the flow of people (the number of visits).

Then, demand prediction system 100 may determine recommended purchase goods and purchase quantity, and the like based on the predicted demand of goods.

As described in the embodiment described above, demand prediction system 100 collects a plurality of event information, each of which is information indicating a current or future event and includes location information indicating a location of an event, through a communication network. Then, demand prediction system 100 extracts event information indicating a predetermined range events including the location of the shop, from the plurality of collected event information based on the location information.

Then, demand prediction system 100 predicts the demand of goods varying at the shop according to the event indicated by the extracted event information based on the actual result information of the past event corresponding to the event indicated by the extracted event information. Then, demand prediction system 100 outputs demand prediction information indicating the predicted demand of goods.

As a result, demand prediction system 100 can appropriately predict the demand of goods varying at the shop according to current or future event, and can provide information indicating the predicted demand of goods. Therefore, demand prediction system 100 can support the appropriate provision of goods.

Although the demand prediction system according to the present disclosure has been described based on the embodiment and the like, the present invention is not limited to the embodiment. A mode obtained by subjecting the embodiment and the like to modifications conceivable by those skilled in the art and another mode realized by optionally combining a plurality of components in the embodiment and the like are also included in the present invention.

For example, another processing unit may execute processing executed by a specific processing unit. Further, the order of executing the processes may be changed, or a plurality of processes may be executed in parallel.

Further, the present invention can be realized not only as a demand prediction system but also as a method in which the processing means constituting the demand prediction system is used as steps. For example, these steps are executed by a computer. Then, the present invention can be realized as a program for causing a computer to execute the steps included in these methods. Furthermore, the present invention can be realized as a non-transitory computer readable recording medium such as a CD-ROM for recording the program.

For example, when the present invention is implemented by a program (software), each functional element of the present invention is realized by executing a program using hardware resources such as a CPU, a memory, an input and output circuit, and the like of a computer. In other words, each functional element is realized by the CPU acquiring the data to be processed from the memory, the input and output circuit, or the like to calculate the data, and outputting the calculation result to the memory, the input and output circuit, or the like.

Further, the plurality of components included in the demand prediction system may be realized as a large scale integration (LSI) which is an integrated circuit. These components may be individually formed into one chip, or may be made into one chip so as to include some or all. Here, although it is an LSI, it may be referred to as an integrated circuit (IC), a system LSI, a super LSI, or an ultra LSI according to the degree of integration.

In addition, the method of circuit integration is not limited to LSI, and it may be realized by a dedicated circuit or a general-purpose processor. A programmable field programmable gate array (FPGA), or a reconfigurable processor capable of reconfiguring connection and setting of circuit cells inside the LSI may be used.

Furthermore, when integrated circuit technology comes out to replace LSI's as a result of the advancement of semiconductor technology or a derivative other technology, it goes without saying that the circuit integration of the components included in the demand prediction system may be performed by using the technology.

As described above, the demand prediction system and the like of the present disclosure can appropriately predict the demand of goods at the shop.

### INDUSTRIAL APPLICABILITY

The demand prediction system and the like according to the present disclosure may be used for predicting demand of goods at a shop, and may be applied to a purchase system for purchasing goods, a delivery system for delivering goods, and the like.

### REFERENCE MARKS IN THE DRAWINGS

100 DEMAND PREDICTION SYSTEM
101 COLLECTION UNIT
102 EXTRACTION UNIT
103 PREDICTION UNIT
104 OUTPUT UNIT
105 STORAGE UNIT
106 STORAGE CONTROL UNIT

What is claimed is:

1. A demand prediction system, comprising:
a collection unit collecting a plurality of event information including event information having an event and location information indicating a location of the event through a communication network, the event being one of a current event and a future event;
an extraction unit extracting event information indicating the event in a predetermined range, which includes a location of a shop from the plurality of event information collected by the collection unit based on the location information;
a prediction unit predicting a demand of goods varying at the shop according to the event indicated by the event information extracted by the extraction unit, based on actual result information on a past event corresponding to the event indicated by the event information extracted by the extraction unit, and
an output unit outputting demand prediction information indicating the demand of goods predicted by the prediction unit.

2. The demand prediction system of claim 1,
wherein the predetermined range is a range that is defined as a range influencing the demand of goods at the shop.

3. The demand prediction system of claim 1,
wherein the event indicated by the event information extracted by the extraction unit is route-related events, road-related events, special events, or current trend in a predetermined range.

4. The demand prediction system of claim 1,
wherein the prediction unit predicts a flow of people varying according to the event indicated by the event information extracted by the extraction unit based on actual result information of the past event, and predicts the demand of goods based on the predicted flow of people.

5. The demand prediction system of claim 4,
wherein the prediction unit predicts at least one of a traffic route, a traffic volume, and a number of visits varying according to the event indicated by the event information extracted by the extraction unit as the flow of people.

6. The demand prediction system of claim 4,
wherein the output unit further outputs crowd prediction information indicating the flow of people predicted by the prediction unit.

7. The demand prediction system of claim 4,
wherein the prediction unit predicts the flow of people and attribute of a person included in the flow of people based on actual result information of the past event and predicts the demand of goods based on the predicted flow of people and the attributes.

8. The demand prediction system of claim 7,
wherein the prediction unit predicts at least one of gender, age and preference of a person included in the flow of people as the attribute.

9. The demand prediction system of claim 7,
wherein the output unit further outputs attribute prediction information indicating the attribute predicted by the prediction unit.

10. A demand prediction method, comprising:
a step of collecting a plurality of event information including event information having an event and location information indicating a location of the event through a communication network, the event being one of a current event and a future event;
a step of extracting event information indicating the event in a predetermined range, which includes a location of a shop from the plurality of event information collected by the collecting step based on the location information,
a step of predicting a demand of goods varying at the shop according to the event indicated by the event information extracted by the extracting step based on actual result information on a past event corresponding to the event indicated by the event information extracted by the extracting, and
a step of outputting demand prediction information indicating the demand of goods predicted in the predicting.

11. A program for executing the demand prediction method of claim 10 by a computer.
